(19) United States
(12) Patent Application Publication
(10) Pub. No.: US 2009/0311432 A1
(43) Pub. Date: Dec. 17, 2009

(54) Methods for smoothing a layer of cellulose material

(76) Inventors: Steven Allan Kempe, Richmond, TX (US); Harry Joe Witt, Richmond, TX (US); William F. Boyer, Pearland, TX (US)

Correspondence Address: Guy McClung;#114, 5315-B F.M., 1960 Rd. West, Houston, TX, 77069-4410, US

(21) Appl. No.: 12/455,579

(22) Filed: Jun. 3, 2009

Related U.S. Application Data
(62) Division of application No. 11/580,219, filed on Oct. 12, 2006, now abandoned.
Application No. 11/580,219 is a division of application No. 10/934,838, filed on Sep. 3, 2004, now abandoned.

(51) Int. Cl. B05D 3/12

(52) U.S. Cl. 427/355

(57) ABSTRACT

A method for producing a smoothed layer of cellulose material on a substrate, including, at least in certain aspects, mixing cellulose material with an adhesive and gelling material in aqueous solution producing a mixture, applying the mixture to a surface of the substrate, the mixture as applied having an outer surface, and smoothing the outer surface with a finishing tool, the finishing tool having a base, optionally a cushion portion adjacent the base, and a smooth non-permeable covering over the base, the smooth non-permeable covering for contacting, pressing against, and moving on the outer surface of the mixture as applied; and such finishing tools for use in such methods.

### CROSS-REFERENCE TO RELATED APPLICATIONS

This is a division of U.S. application Ser. No. 11/580,219 filed Oct. 12, 2006 and Ser. No. 10/934,838 filed Sep. 3, 2004, now abandoned, both co-owned with the present invention, both fully incorporated herein for all purposes, and from both of which the present invention claims priority under the Patent Laws.

### BACKGROUND OF THE INVENTION

1. Field of the Invention

This invention is directed to: cellulose material applied to a substrate; methods for applying such material; and such material that is aesthetically pleasing following installation.

2. Description of Related Art

A wide variety of spray-on cellulose materials and systems for applying to ceilings, floors, and walls are disclosed in the prior art. U.S. Pat. Nos. 4,187,983; 4,360,440; 4,923,121; 5,082,563; 5,352,780; 5,429,741; 5,684,068; 5,853,802; 6,251,476; and 6,737,106 provide a sampling of the numerous patents directed to such materials and systems.

Two-component adhesive resins are commonly used with sprayed-on and blown-in fibrous cellulose insulating materials. U.S. Pat. No. 4,187,983, co-owned with the present invention discloses prior art systems for applying fibrous cellulose insulation material with an adhesive. U.S. Pat. No. 4,360,440, co-owned with the present invention discloses Insulating fiber mixtures that include water, fibers, and an adhesive that is a combination of sodium silicate and an acrylic resin. U.S. Pat. Nos. 5,684,068; 5,853,802; 6,251,476 and 6,737,106 co-owned with the present invention and fully incorporated herein for all purposes, disclose compositions with cellulose fibers.

Many cellulose materials are applied in areas that either are never or rarely viewed by people or are in areas in which appearance is not important. Many typical cellulose materials as applied have a rough, pitted, irregular, uneven, gritty, and/or nonuniform surface which would not be suitable for many uses, e.g., but not limited to, for use in many offices, hotels, retail facilities and interior residential rooms. In many such applications, including some that are architecturally demanding, plaster or a plaster-like material is used on walls, partitions, or ceilings. Plaster materials have been used in certain high demand aesthetic applications for many years. Certain of these plasters are typically mixed into a slurry, pumped through a machine, and then applied to or sprayed onto a surface, e.g. a ceiling or wall. Although such uses of plaster are common, there are some drawbacks to certain plaster products and certain application methods in that they tend to be slower to install, require relatively expensive equipment, have relatively low acoustical absorption characteristics, and can be generally difficult to work with.

Previous efforts to provide a cellulose material that, as installed, meets the requirements for these architecturally demanding applications, include efforts to vary the nature and source of raw materials, manufacturing procedures, application techniques, and equipment modifications. One particular effort to provide cellulose material with an acceptable surface included tamping with a flat or planned board pressed into the surface of newly applied material. While this method can result in some reduction of surface texture, it often is time consuming, can require great care on the part of the applicator to apply the “correct” pressure consistently throughout an area, can be difficult to use on irregular or curved surfaces, and can be relatively slow and labor intensive. Another attempted method was to roll a surface shortly after application of cellulose material with a paint roller or similar rolling tool. This provided some reduction of the texture, but is also very demanding on the part of the applicator for similar reasons as described for tamping. Further, in both cases, should any material adhere to the tamping board or rolling tool (a common undesirable occurrence due to the nature of the material and/or adhesive therein), surface irregularities or damage to the installed material can occur and may be difficult or impossible to repair. Even with a high level of care and expertise, lines, ridges, gouges and/or patterns of tamping or rolling tools used can occur. Both methods can produce uneven results due to the variances in the applied material and the skill and consistency of the applicator or applicators.

In many aspects cellulose insulation can be installed in thicknesses up to 5 inches or more, while in certain applications the thickness is below 1 inch. In some of these applications, the final thickness may be as thin as ¼ inch or less. These thin applications place extremely high demands on the final appearance.

There has long been a need, recognized by the present inventors, for aesthetically pleasing applied cellulose materials and methods and tools for applying and finishing such materials. There has long been such a need, recognized by the present inventors, for methods for applying such materials which are not labor intensive and/or which can be accomplished with uniformity prior to a final set of adhesives in the materials.

### SUMMARY OF THE PRESENT INVENTION

The present invention, in certain embodiments, discloses a cellulose mixture that includes cellulose fibers; an adhesive mixture; optionally, a dispersant; and, optionally, a gelling agent. The present invention, in certain embodiments, discloses methods for applying a layer of cellulose material on a substrate, the methods including mixing cellulose with an adhesive in aqueous solution producing a cellulose mixture, applying the cellulose mixture to a surface of a substrate, the cellulose mixture as applied having an outer surface, and smoothing the outer surface of the cellulose mixture with a finishing tool, the finishing tool having a base including a smooth non-permeable portion, the smooth non-permeable portion for contacting, pressing against, and moving on the outer surface of the cellulose mixture as applied to produce an aesthetically pleasing surface.

The present invention discloses a finishing tool that is movable over an amount of applied cellulose material. In one aspect such a tool includes a base made of and/or covered by a smooth nonpermeable material (a material to which adhesive and components of the cellulose material will not adhere or to which they adhere poorly), e.g., but not limited to, bases, coverings, films, or sheets of vinyl, polyethylene, or polyurethane. In one particular aspect a sheet of vinyl material (e.g. between about 2 mils to 8 mils thick; in one aspect, 4 mils thick; in one aspect 18 gauge) is used to cover the base. For a base covering materials may be used which slide easily over the surface of applied cellulose material, even under some pressure with no or minimal applied cellulose material sticking to the base covering material. Optionally, a handling or gripping structure is provided on the base to facilitate manual movement of the base over the cellulose material. Optionally, a layer or mass of foam, cushion, spongy material, soft fabric, or similar material is secured to the base and the smooth material covers the cushion or foam (or other material). The cushion, foam, or other material, may range in thickness in certain aspects between one-fourth and two inches. Optionally, the base has one or more curved or bevelled edges to facilitate movement on the cellulose material. Moving such a finishing tool with sufficient (but not extreme) pressure over an amount of cellulose material applied on a surface, smooths the outer surface of the material rendering it aesthetically pleasing.

The present invention also provides, in certain aspects, cellulose material with a gelling agent, such as borax, and an adhesive, such as a polyvinyl-alcohol-containing adhesive. Such material is very workable with a finishing tool according to the present invention. In certain embodiments adhesive is added at levels contrary to certain recommendations in the prior art. Boric acid is also used, in certain embodiments, as a treatment for cellulose material, as mold resistant, insect repellant, and/or flammability reducer.

In certain particular aspects of the present invention a finishing tool is provided which has a portion removed from the base so that movement of the tool over an amount of applied cellulose materials results in the movement of two leading curved or bevelled edges over the material in a single pass of the tool, facilitating smoothing of the material's surface and reducing the total number of tool passes over the material.

What follows are some of, but not all, the objects of at least certain aspects and embodiments of this invention. In addition to the specific objects stated below for at least certain preferred embodiments of the invention, other objects and purposes will be readily apparent to one of skill in this art who has the benefit of this invention's teachings and disclosures.

It is, therefore, an object of at least certain preferred embodiments of the present invention to provide: new, useful, unique, efficient, nonobvious applied (e.g. trowelled on or sprayed-on) cellulose materials and methods of their application.

It is, therefore, an object of at least certain preferred embodiments of the present invention to provide: new, useful, unique, efficient, nonobvious finishing tools for finishing a surface of applied cellulose material, and methods of their use.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1 is a schematic view of a prior art cellulose material application method.

FIG. 2A is a top view of a finishing tool according to the present invention. FIG. 2B is a side view of the finishing tool of FIG. 2A. FIG. 2C is a partial cross-section view of the tool of FIG. 2A.

FIG. 3A is a top view of a finishing tool according to the present invention. FIG. 3B is a side view of the finishing tool of FIG. 3A. FIGS. 3C and 3D are in cross-section views of the finishing tool of FIG. 3A.

FIG. 4A is a top view of a finishing tool according to the present invention. FIG. 4B is a side view of the finishing tool of FIG. 4A.

FIG. 5 is a top view of a variety of shapes, as viewed from above, for finishing tools according to the present invention.

FIGS. 6A, 6B and 6D are cross-section views of tools according to the present invention. FIG. 6C is a top view of the tool of FIG. 6D.

FIG. 7 is a Table presenting analyses of cellulose mixtures.

### DESCRIPTION OF EMBODIMENTS PREFERRED AT THE TIME OF FILING FOR THIS PATENT

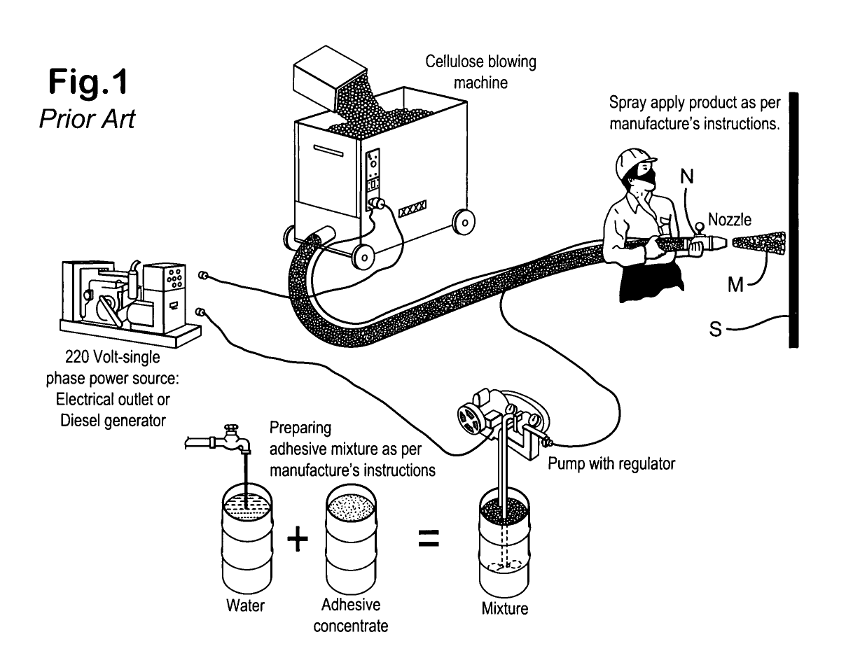

FIG. 1 shows one typical prior art system for spraying cellulose material M through a nozzle apparatus N onto a substrate S.

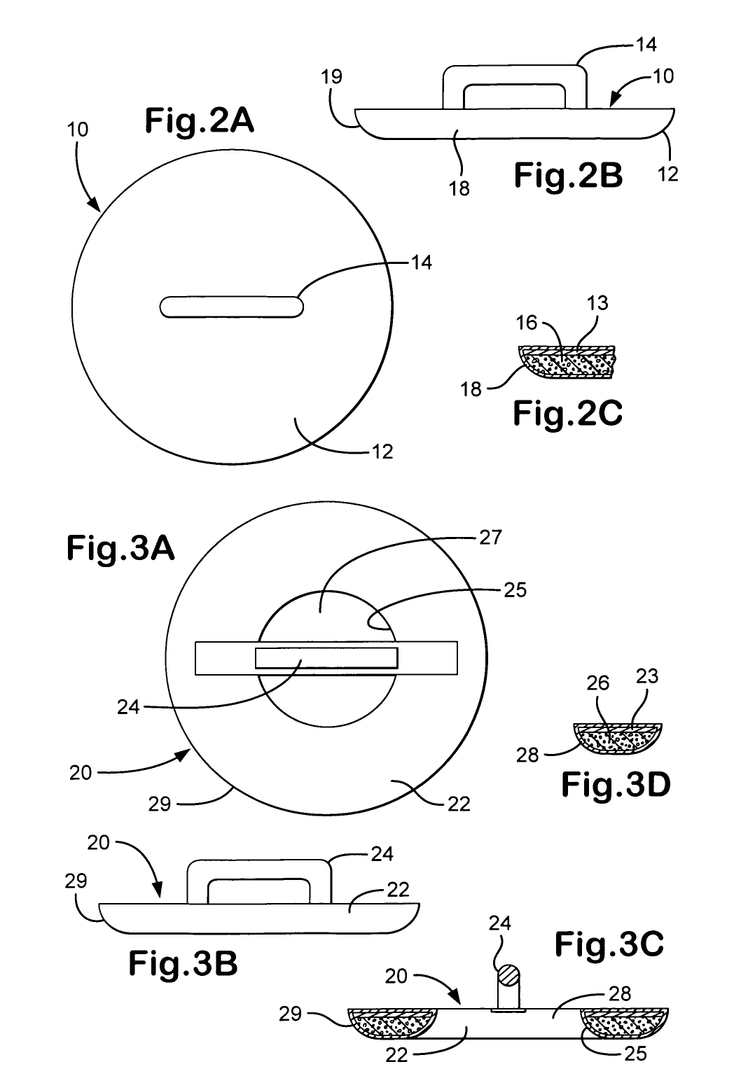

FIGS. 2A, 2B and 2C show a finishing tool 10 according to the present invention which has a base 12 with a base member 13, a handle 14, a foam layer 16 (optional as is any foam or cushion layer or portion herein) and a vinyl covering 18. The handle 14 (as may be any handle of any embodiment herein) may be a separate piece connected to the base 12 or it may be formed integrally of the base 12. The foam layer (as may be any foam or cushion layer or portion of any embodiment herein) may be connected to the base with fasteners (e.g., but not limited to screws, brads, or staples) and/or it may be glued or adhered to the base 12. Although it is within the scope of the present invention to have a base with squared edges, the base 12 as shown has a curved outer edge 19.

FIGS. 3A-3D show a finishing tool 20 according to the present invention which has a base 22 with a base member 23, a handle 24, a cushion layer 26, and a vinyl covering 28. The tool 20 is similar to the tool 10, but the base 22 has a cut out portion 23 and an inner curved edge 25. The base 22 has a curved outer edge 29. Movement of the tool 20 over an amount of applied cellulose material results in both edges 29 and 25 moving on the material so that two edges rather than one smooth the surface of the material in a back-and-forth pass of the tool over applied cellulose.

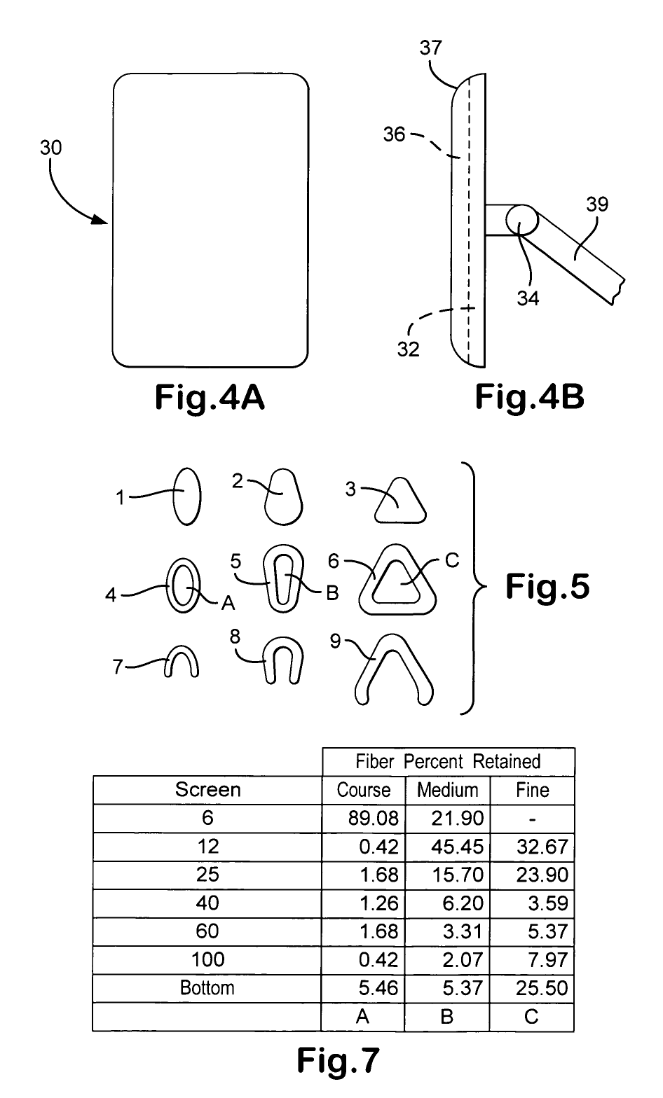

FIGS. 4A and 4B show a finishing tool 30 according to the present invention which has a base 32, a pivotable joint connector 34, a foam layer 36 and a shaft 39 releasably connected to the joint connector 34. The shaft 39 may be any desired shape in cross-section and may be any desired length, and may, optionally, include multiple telescoping parts. The base 32 has a curved outer edge 37.

FIG. 5 shows top views of shapes 1-9 for finishing tools according to the present invention, some with cut out portions A, B, C and some (7-9) with spaced apart ends. Such tools may have any base, covering, handle, and/or air pocket(s) of any embodiment disclosed herein.

In certain aspects of a cellulose material useful in methods according to the present invention, the workability or smoothability of the material is enhanced as compared to certain prior art materials by adding a gelling material, e.g. borax borates, potassium sulfate, sodium, and/or sodium bicarbonate to a polyvinyl-alcohol-adhesive used in the cellulose material and using cellulose fibers containing treated with boric acid (e.g. as described in U.S. Pat. Nos. 6,737,106 and 6,251,476). In one particular embodiment of such a cellulose material, a relatively high viscosity partially hydrolyzed grade polyvinyl alcohol is used, e.g., but not limited to, commercially available DuPont Company 50-42 adhesive. The polyvinyl alcohol adhesive is blended with water to form an adhesive mixture prior to use and then the adhesive mixture is added to sprayed cellulose material during application at a controlled and, in one aspect, predetermined rate. Adhesive mixtures in certain aspects include from 3 parts water to 10 or more parts water per one part of adhesive concentrate. Add on rates of the adhesive mixture per each pound of cellulose fiber, in certain aspects, may range from less than 0.10 gallon per pound to 0.32 gallons per pound. It may also be desirable to vary and adjust these ratios to accommodate specific material and end-use parameters.

In certain aspects by combining polyvinyl-alcohol-containing adhesive mixture with boric-acid treated cellulose fibers containing a level of gelling agent such a borax, the level of adhesive mixture add on can be increased to a level of 0.42 gallons of adhesive mixture per pound of cellulose fiber, an increase of over 30% as compared to certain previously recommended mixtures for certain acoustical applications. A resulting increase in initial wetness produces desired characteristics while diminishing problems associated with too high of an add on rate. It is believed that this is made possible by the fact that the proper gelling of the adhesive mixture binds up additional water thereby preventing or reducing undesirable consequences of too much water used in an application. In certain aspects an add on level of total material in a mixture by weight (“total material mixture” includes the fibers plus all additions; in one aspect, the fibers, borax, and boric acid) to treated cellulose fiber is approximately 18-20% the level of borax by weight is 4% or greater than 4% (e.g. 4% to 14%); and boric acid is less than 16% by weight of the total mixture.

The actual physical size of the cellulose fibers can affect the workability and final appearance. In prior art methods applied cellulose material is used for a wide range of thermal, acoustical, and insulation purposes. In certain applications the material is used as an acoustical finish in environments in which the appearance is far more demanding such as in a church, conference room, classroom, etc. In these applications a typical thickness is 0.5 inches whereas in many thermal or more general purpose applications the thickness is 2, 3 or even 5 inches. In order to address the demands of aesthetic qualities for certain applications with methods according to the present invention, the fiber size of cellulose fibers in a fibrous mixture may be relatively small when compared to that which is better suited for applications of greater thickness.

In certain aspects and embodiments of the present invention the ability to smooth out (“workability”) a surface of applied cellulose material is related to the size of pieces of the cellulose material. When the pieces of cellulose material are fibrous, workability depends on fiber size and percentages (by weight) of various different size fibers which are in a particular mixture. Sieve analysis yields a measurement of various fiber sizes of the fibers in a particular mixture. For example a screen with a sieve number “6” (see, e.g. FIG. 7, column designated “Screen”) has a #6 mesh which means six holes per linear inch each hole with an opening of 0.132′ (3.36 mm; 3360 microns). As an example, if a material is described as “−40 mesh”, 90% or more of the material introduced to it passes through a 40 Mesh sieve (particles are smaller than 0.0165″, 0.420 mm, 420 microns).

As shown in FIG. 7, three cellulose fiber mixtures, A, B, C, useful in embodiments of the present invention have been subjected to sieve analysis. The designations “Coarse, “Medium,” and “Fine” are general characterizations of the majority of fibers in a particular mixture. With respect to workability, the mixture C designated “Fine” was found to have the best workability with over 50% of its fibers passing through a No. 6 sieve. In particular aspects of such fiber mixtures according to the present invention, all the fibers pass through a No. 6 sieve and more than 50%, more than 55%, or more than 60% of the fibers pass through a No. 12 sieve. In other aspects at least 75% of the fibers pas through a No. 6 sieve. “Bottom” refers to a bottom pan or receptacle which catches materials small enough to pass through all sieves above it. “Fiber Percent Retained” is the percentage of fibers in a fibrous cellulose mixture which are retained on (do not pass through) a given sieve. The entries in the “Screen” column are numerical values for Tyles Equivalent Mesh values. In certain aspects, good workability is achieved when at least 30% of the fibers in a fibrous cellulose mixture can pass through a No. 12 Mesh sieve.

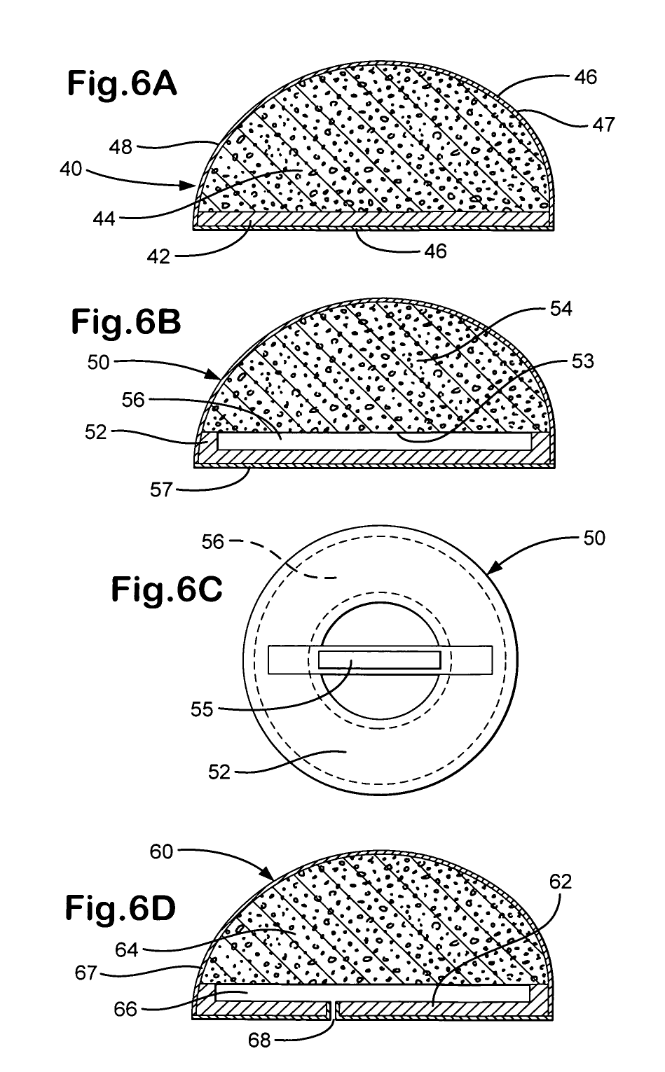

FIG. 6A shows a cross-section of a portion of a finishing tool 40 according to the present invention (which may be used for any tool according to the present invention as may be the structures and/or material in FIGS. 6B-6D. The tool 40 has a base 42 on which is mounted, placed and/or connected (e.g. glued or adhered) a cushion portion 44. In certain aspects (as is true for any cushion part, portion or pad of any embodiments herein) the cushion portion 44 is made of flexible foam, rubber, rubberized fibers, flexible plastic, down, Kapok, flexible glass fibers, or the like. A smooth covering 46, e.g. vinyl or polyurethane sheet or film, encompasses the cushion portion 44 and the base 42 (although such a covering on the base 42, as will all bases of all embodiments herein, is optional). The shape (viewed in cross-section as in FIG. 6A) presents two curved edges 47, 48 for contacting applied cellulose.

FIGS. 6B and 6C show a tool 50, similar to the tool 40, but with an air pocket 56 which encircles part of a base 52 and which has a boundary defined by a lower surface 53 of a cushion portion 54. It is within the scope of this invention to provide, one, two, three, or more or a large multiplicity of air pockets adjacent and/or within a cushion portion or pad of any tool according to the present invention. The tool 50 has a vinyl covering 57 and a handle 55.

FIG. 6D shows a tool 60 according to the present invention, similar to the tool 50, but with at least one air vent 68 through which air can pass from an air pocket 66 when pressure is applied to the tool 60. The vent (or vents) 68 are, in one aspect, sized to permit gradual collapse of the air pocket 66 during a smoothing pass over a surface of applied cellulose material. The tool 60 has a base 62, a cushion member 64, and a vinyl covering 67.

Coverings according to the present invention are, in certain aspects, tight fitting and wrinkle-free. In certain aspects coverings are applied to bases and/or to cushion portions or pads by processes including: lamination; adhesion; coating; or film-forming.

The present invention, therefore, in at least certain, but not necessarily all, embodiments provides a method for applying a layer of cellulose material on a substrate, the method including: mixing cellulose with an adhesive in aqueous solution producing a cellulose mixture; applying the cellulose mixture to a surface of a substrate, the cellulose mixture as applied having an outer surface; and smoothing the outer surface of the cellulose mixture with a finishing tool, the finishing tool having a base and a smooth non-permeable covering over the base, the smooth non-permeable covering for contacting, pressing against, and moving on the outer surface of the cellulose mixture as applied. Such a method may include one or some (in any possible combination) of the following: wherein the adhesive contains polyvinyl alcohol; wherein the finishing tool's base has a central cut out portion extending through the base, the central cut out portion having an interior edge defined by the base, the interior edge having a curved shape and the base having an outer peripheral edge with a curved shape, the method further including moving the finishing tool back and forth on the outer surface of the cellulose mixture so that in so moving both curved edges facilitate smoothing of the outer surface; wherein the finishing tool's base has two spaced-apart ends; wherein the finishing tool includes a cushion layer (e.g. pad, foam portion) between the base and the covering over the base; wherein the ratio by volume of water to adhesive in the aqueous solution containing adhesive is between 3:1 to 10:1; wherein between 0.10 gallons and 0.32 gallons of mixed adhesive is used per pound of cellulose; wherein about 0.42 gallons of adhesive in aqueous solution is used per pound of cellulose; prior to the mixing step, treating the cellulose with an acidic material; wherein the acidic material is boric acid; wherein the cellulose mixture is applied by spraying it onto the substrate; wherein the cellulose mixture is applied to the substrate manually, e.g., with a trowel; wherein the cellulose is fibrous cellulose fibers and at least 50% of the fibers pass through a No. 12 mesh sieve to enhance workability of the cellulose mixture with the finishing tool; wherein the cellulose is fibrous cellulose fibers and at least 75% of the fibers pass through a No. 6 mesh sieve to enhance workability of the cellulose mixture with the finishing tool; and/or wherein the cellulose is fibrous cellulose fibers and at least 40% of the fibers pass through a No. 25 mesh sieve to enhance workability of the cellulose mixture with the finishing tool.

The present invention, therefore, in at least certain but not necessarily all preferred embodiments provides a finishing tool useful in producing a layer of cellulose material on a substrate, the cellulose mixed with an adhesive in aqueous solution and applied to a surface of the substrate, the cellulose mixture as applied having an outer surface, the finishing tool having a base, and a smooth non-permeable covering over the base, the smooth non-permeable covering for contacting, pressing against, and moving on the outer surface of the cellulose mixture as applied. Such a tool may include one or some (in any possible combination) of the following: wherein the smooth non-permeable covering is made of vinyl; wherein the base has a central cut out portion extending through the base, the central cut out portion with an interior edge defined by the base, the interior edge having a curved shape, and the base having an outer peripheral edge with a curved shape; a cushion portion (pad, layer) between the base and the smooth non-permeable covering; at least one air pocket or a plurality of spaced-apart air pockets between the base and the cushion portion; at least one vent or a plurality of vents in fluid communication with the at least one air pocket or one vent in fluid communication with each of a plurality of air pockets and the exterior of the finishing tool for venting air from the at least one air pocket or the air pockets; and/or the at least one vent is sized to permit air to flow from the at least one air pocket so that the at least one air pocket collapses gradually as the finishing tool is pressed down on an amount of applied cellulose.

The present invention, therefore, in at least certain but not necessarily all preferred embodiments provides a finishing tool useful in producing a layer of cellulose material on a substrate, the cellulose mixed with an adhesive in aqueous solution and applied to a surface of the substrate, the cellulose mixture as applied having an outer surface, the finishing tool having a base which itself made of a smooth non-permeable material and/or a covering over the base, the covering made of smooth non-permeable material (in which case the base may be made of any suitable material, smooth and non-permeable or otherwise) for contacting, pressing against, and moving on the outer surface of the cellulose mixture as applied; a central cut out portion extending through the base, the central cut out portion having an interior edge defined by the base, the interior edge having a curved shape, and the base having an outer peripheral edge with a curved shape; and a cushion portion between the base and the smooth non-permeable covering.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventor may rely on the Doctrine of Equivalents to determine and assess the scope of their invention and of the claims that follow as they may pertain to apparatus not materially departing from, but outside of, the literal scope of the invention as set forth in the following claims. Any patent or patent application referred to herein is incorporated fully herein for all purposes.

What is claimed is:

1. A method for smoothing a layer of cellulose material on a substrate, the method comprising
adding water and a gelling material to a polyvinyl alcohol adhesive forming an adhesive mixture, the gelling material for binding water to control water used in said smoothing of a layer,
treating cellulose with boric acid to form a cellulose mixture, wherein the cellulose is fibrous cellulose comprising cellulose fibers and at least 30% of the cellulose fibers pass through a No. 12 mesh sieve to enhance smoothability of the cellulose mixture as applied to a substrate with a finishing tool,
applying the cellulose mixture to a surface of a substrate, the cellulose mixture as applied having an outer surface smoothable with a finishing tool,
adding the adhesive mixture to the cellulose mixture during applying of the cellulose mixture to the surface, and
finishing the outer surface of the cellulose mixture with a finishing tool to smooth the outer surface.

2. The method of claim 1 wherein the ratio by volume of water to adhesive in the adhesive mixture is between 3:1 to 10:1.

3. The method of claim 1 wherein between 0.10 gallons and 0.32 gallons of adhesive mixture is used per pound of cellulose to increase initial wetness of the cellulose mixture.

4. The method of claim 1 wherein about 0.42 gallons of adhesive mixture is used per pound of cellulose to increase initial wetness of the cellulose mixture.

5. The method of claim 1 wherein the at least 30% is at least 50%.

6. The method of claim 1 wherein
at least 40% of the cellulose fibers pass through a No. 25 mesh sieve.

7. The method of claim 1 wherein
the gelling material is borax,
a total material mixture includes the cellulose fibers, the borax and the boric acid, and
an add on level of the total material mixture by weight to treated cellulose fiber is between about 18% to 20%.

8. The method of claim 7 wherein
the level of borax by weight is less than 16% of the total material mixture.

9. The method of claim 7 wherein the boric acid is less than 16% by weight of the total material mixture.

10. The method of claim 1 wherein the finishing tool has a base and the base has a central cut out portion extending through the base, the central cut out portion has two leading edges including an interior edge defined by the base, the interior edge having a curved shape, and the base has an outer peripheral edge with a curved shape, the method further comprising
Moving the finishing tool back and forth on the cellulose mixture so that the two leading edges smooth the cellulose material.

11. The method of claim 1 wherein the finishing tool has a smooth non-permeable covering and a cushion portion between the base and the smooth non-permeable covering, at least one air pocket between the base and the cushion portion, at least one vent in fluid communication with the at least one air pocket and the exterior of the finishing tool for venting air from the at least one air pocket, the at least one vent sized to permit air to flow from the at least one air pocket so that the at least one air pocket collapses gradually as the finishing tool is pressed down on an amount of applied cellulose, the method further comprising
pressing the finishing tool down on the cellulose mixture as applied as air flows from the at least one air pocket, the at least one air pocket collapsing gradually.

12. A method for smoothing a layer of cellulose material on a substrate, the method comprising
adding water and a gelling material to a polyvinyl alcohol adhesive forming an adhesive mixture, the gelling material for binding water to control water used in said smoothing of a layer,
treating cellulose with boric acid to form a cellulose mixture, wherein the cellulose is fibrous cellulose comprising cellulose fibers and at least 50% of the cellulose fibers pass through a No. 12 mesh sieve to enhance smoothability of the cellulose mixture with a finishing tool,
applying the cellulose mixture to a surface of a substrate, the cellulose mixture as applied having an outer surface smoothable with a finishing tool,
adding the adhesive mixture to the cellulose mixture during applying of the cellulose mixture to the surface,
finishing the outer surface of the cellulose mixture with a finishing tool to smooth the outer surface,
wherein the ratio by volume of water to adhesive in the adhesive mixture is between 3:1 to 10:1,
wherein between 0.10 gallons and 0.32 gallons of adhesive mixture is used per pound of cellulose to increase initial wetness of the cellulose mixture,
wherein the gelling material is borax,
a total material mixture includes the cellulose fibers, the borax and the boric acid,
an add on level of the total material mixture by weight to treated cellulose fiber is between about 18% to 20%,
wherein the level of borax by weight is between 4% to 14% of the total material mixture, and
wherein the boric acid is less than 16% by weight of the total material mixture.

13. A method for smoothing a layer of cellulose material on a substrate, the method comprising
adding water and a gelling material to a polyvinyl alcohol adhesive forming an adhesive mixture, mixture, the gelling material for binding water to control water used in said smoothing of a layer,
treating cellulose with boric acid to form a cellulose mixture, wherein the cellulose is fibrous cellulose comprising cellulose fibers and at least 50% of the cellulose fibers pass through a No. 12 mesh sieve to enhance workability of the cellulose mixture with a finishing tool,
applying the cellulose mixture to a surface of a substrate, the cellulose mixture as applied having an outer surface workable with a finishing tool,
adding the adhesive mixture to the cellulose
mixture during applying of the cellulose mixture to the surface, and
finishing the outer surface of the cellulose mixture with a finishing tool to smooth the outer surface.

14. The method of claim 13 wherein the ratio by volume of water to adhesive in the adhesive mixture is between 3:1 to 10:1.

15. The method of claim 13 wherein between 0.10 gallons and 0.32 gallons of adhesive mixture is used per pound of cellulose to increase initial wetness of the cellulose mixture.

16. The method of claim 13 wherein about 0.42 gallons of adhesive mixture is used per pound of cellulose to increase initial wetness of the cellulose mixture.

17. A method for smoothing a layer of cellulose material on a substrate, the method comprising
adding water and a gelling material to a polyvinyl alcohol adhesive forming an adhesive mixture, the gelling material for binding water to control water used in said smoothing of a layer,
treating cellulose with boric acid to form a cellulose material, wherein the cellulose is fibrous cellulose comprising cellulose fibers and at least 40% of the cellulose fibers pass through a No. 25 mess sieve to enhance workability of the cellulose mixture with a finishing tool,
applying the cellulose mixture to a surface of a substrate, the cellulose mixture as applied having an outer surface workable with a finishing tool,
adding the adhesive mixture to the cellulose mixture during application of the cellulose mixture to the surface, and
finishing the outer surface of the cellulose mixture with a finishing tool to smooth the outer surface.

18. The method of claim 17 wherein the ratio by volume of water to adhesive in the adhesive mixture is between 3:1 to 10:1.

19. The method of claim 17 wherein between 0.10 gallons and 0.32 gallons of adhesive mixture is used per pound of cellulose to increase initial wetness of the cellulose mixture.

20. The method of claim 17 wherein about 0.42 gallons of adhesive mixture is used per pound of cellulose to increase initial wetness of the cellulose mixture.
